(19) United States
(12) Patent Application Publication
(10) Pub. No.: US 2009/0326864 A1
(43) Pub. Date: Dec. 31, 2009

(54) DETERMINING THE RELIABILITY OF AN INTERCONNECT

(75) Inventors: David K. McElfresh, San Diego, CA (US); Dan Vacar, San Diego, CA (US); Leoncio D. Lopez, Escondido, CA (US); Kenny C. Gross, San Diego, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/147,705

(22) Filed: Jun. 27, 2008

(51) Int. Cl. G06F 17/18; G06F 19/00

(52) U.S. Cl. 702/179; 702/182

(57) ABSTRACT

Some embodiments of the present invention provide a system that determines the reliability of an interconnect. During operation, connectors in the interconnect are categorized into a set of predetermined groups. Next, the reliability for selected groups in the set of predetermined groups is determined. Then, a reliability model for the interconnect is generated based on the selected groups and the reliability of the selected groups to determine the overall reliability of the interconnect.

### BACKGROUND

1. Field

The present invention generally relates to techniques for improving the reliability of computer systems. More specifically, the present invention relates to a method and an apparatus for determining the reliability of an interconnect.

2. Related Art

Accurate reliability modeling for interconnects can be very important during the process of designing and selecting components for computer systems. Typically, existing reliability modeling techniques treat interconnects as being composed of connectors that contribute equally to the overall reliability of the interconnect. However, connectors in an interconnect often perform different functions and may be exposed to different factors during operation that can impact both their behavior and their importance to the overall functioning of the interconnect. Without taking these differences into account, reliability models may produce inaccurate reliability estimates for interconnects.

Hence, what is needed is a method and an apparatus for determining the reliability of an interconnect without the problems described above.

### SUMMARY

Some embodiments of the present invention provide a system that determines the reliability of an interconnect. During operation, connectors in the interconnect are categorized into a set of predetermined groups. Next, the reliability for selected groups in the set of predetermined groups is determined. Then, a reliability model for the interconnect is generated based on the selected groups and the reliability of the selected groups to determine the overall reliability of the interconnect.

In some embodiments, the selected groups are selected based on at least one of: a connector function, a connector location, a connector construction, and a connector stress.

In some embodiments, generating the reliability model for the interconnect includes prioritizing at least two of the selected groups based on the reliability of the two selected groups.

In some embodiments, generating the reliability model for the interconnect includes determining a response to an alarm based on characteristics of the selected group generating the alarm.

In some embodiments, generating the reliability model for the interconnect includes estimating a remaining useful life of the interconnect based on the alarm.

In some embodiments, determining the reliability for a selected group from the set of predetermined groups includes generating a reliability model for the selected group.

In some embodiments, generating the reliability model for the interconnect includes generating the reliability model for the reliability of the interconnect based on a reliability model for a selected group.

In some embodiments, determining the reliability for the selected groups in the set of predetermined groups includes using a nonlinear, non-parametric regression technique.

In some embodiments, using the nonlinear, non-parametric regression technique includes using a multivariate state estimation technique (MSET).

In some embodiments, determining the reliability for the selected groups in the set of predetermined groups includes using a sequential probability ratio test (SPRT) technique.

In some embodiments, using the SPRT technique includes testing for at least one of the following: a positive deviation in a mean, a negative deviation in the mean, a positive deviation in a variance, a negative deviation in the variance, a positive deviation in a derivative of the mean, a negative deviation in a derivative of the mean, a positive deviation in a derivative of the variance, and a negative deviation in a derivative of the variance.

### BRIEF DESCRIPTION OF THE FIGURES

FIG. 1A depicts a reliability test mechanism that generates reliability models for connectors in an interconnect in which the connectors are categorized into selected groups in accordance with some embodiments of the present invention.

FIG. 1B depicts connectors in an interconnect categorized into selected groups in accordance with some embodiments of the present invention.

FIG. 2 presents a flowchart illustrating a process for determining a reliability of an interconnect in accordance with some embodiments of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

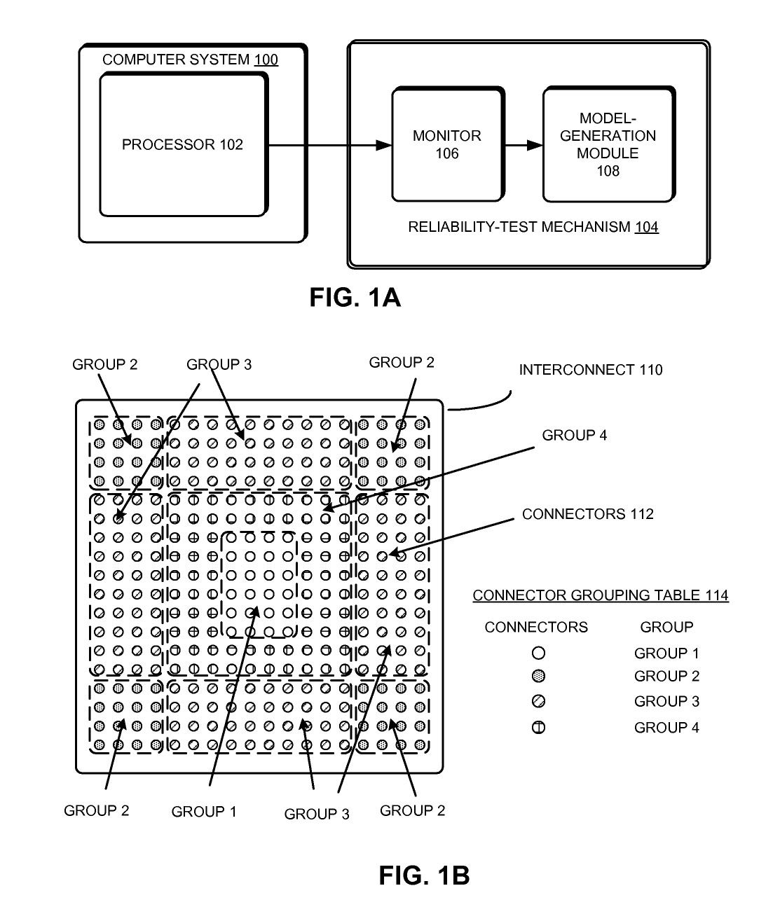

FIG. 1A depicts a reliability-test mechanism that generates reliability models for connectors in an interconnect in which the connectors are categorized into selected groups in accordance with some embodiments of the present invention. Referring to FIG. 1A, computer system 100 includes processor 102. Moreover, reliability-test mechanism 104, which is coupled to computer system 100, includes monitor 106 and model-generation module 108. Note that monitor 106 is coupled to both processor 102 and model-generation module 108.

Computer system 100 can include but is not limited to a server, a server blade, a datacenter server, an enterprise computer, a field-replaceable unit that includes a processor, or any other computation system that includes one or more processors and one or more cores in each processor.

Processor 102 can generally include any type of processor, including, but not limited to, a microprocessor, a mainframe computer, a digital signal processor, a personal organizer, a device controller, a computational engine within an appliance, and any other processor now known or later developed. Furthermore, processor 102 can include one or more cores. Processor 102 is coupled to computer system 100 through interconnect 110 depicted in FIG. 1B. FIG. 1B depicts connectors 112 shown as circles in interconnect 110 categorized into selected groups in connector grouping table 114, in accordance with some embodiments of the present invention. Note that the number of connectors 112 depicted in interconnect 110 is provided for illustrative purposes only and interconnect 110 can have more or fewer connectors without departing from the present invention. (FIG. 1B will be discussed in more detail below.)

Monitor 106 can be any device that can monitor parameters of computer system 100 and processor 102 related to generating a reliability model in accordance with embodiments of the present invention. In some embodiments, monitor 106 additionally monitors parameters of a reliability test apparatus, which can include a device for controlling the environment around computer system 100. Monitor 106 can be implemented in any combination of hardware and software. In some embodiments, monitor 106 operates on computer system 100. In other embodiments, monitor 106 operates on one or more service processors. In still other embodiments, monitor 106 is located inside computer system 100. In yet other embodiments, monitor 106 operates on a separate computer system. In some embodiments, monitor 106 includes an apparatus for monitoring and recording computer system performance parameters as set forth in U.S. Pat. No. 7,020,802, entitled “Method and Apparatus for Monitoring and Recording Computer System Performance Parameters,” by Kenny C. Gross and Larry G. Votta, Jr., issued on 28 Mar. 2006, which is hereby fully incorporated by reference.

Model-generation module 108 can be any device that can receive input from monitor 106 and generate a reliability model in accordance with embodiments of the present invention. Model-generation module 108 can be implemented in any combination of hardware and software. In some embodiments, model-generation module 108 operates on computer system 100. In other embodiments, model-generation module 108 operates on one or more service processors. In still other embodiments, model-generation module 108 is located inside computer system 100. In yet other embodiments, model-generation module 108 operates on a separate computer system.

Some embodiments of the present invention operate as follows. First, connectors 112 in interconnect 110 are separated into groups. FIG. 1B depicts interconnect 110 with connectors 112 divided into groups based on the properties of each connector 112. The type of circle used to represent each connector 112 signifies the group it belongs to as shown in connector grouping table 114. For illustrative purposes, connectors 112 in interconnect 110 are divided into 4 groups. Properties that can be used to categorize connectors 112 into groups can include but are not limited to one or more of the following: the location of a connector in the interconnect 110; the operating environment of the connector; the effect on the connector of material properties or material property mismatches between the interconnect and what it connects to or is mounted on, the type of signal carried by the connector; the construction of the connector; or any other property that can be related to reliability of a connector or interconnect 110.

In the example of FIG. 1B, the 4 groups are: connectors that do not have a high likelihood of causing disruptive field failures, including redundant power and ground connectors; connectors that have no redundancy or fail-over protection, including non-redundant clock and I/O connectors; connectors subjected to higher stress, including solder joints and connections furthest from a neutral point; and connectors subjected to higher stress due to proximity to material transitions, coefficient of thermal expansion mismatches, spatial and temperature discontinuities or large gradients and/or being located at a corner or other high stress location. In some embodiments, more or fewer groups are used, and other grouping metrics can be used to group connectors 112, including but not limited to, any property of a connector that can affect the performance of interconnect 110 or computer system 100.

Next, reliability testing is conducted for the groups of connectors 112 in interconnect 110 in computer system 100. In some embodiments, any suitable reliability testing process known in the art can be used, including but not limited to accelerated temperature cycling, vibration testing, humidity testing, mixed flow gas testing, or any other reliability test or combination of tests now known or later developed. During the reliability testing, monitor 106 separately monitors parameters of each of the 4 groups of connectors 112 in interconnect 110 and transmits the parameters to model-generation module 108. In some embodiments, monitor 106 also monitors reliability test parameters such as temperature-cycling data, vibration data, gas and environmental data, humidity data, and any other data related to the reliability testing.

Model-generation module 108 generates a reliability model for each group of connectors 112 in interconnect 110 based on the parameters monitored by monitor 106 during the reliability testing. In some embodiments, monitor 106 monitors one or more representative connectors in each group during the reliability testing, while in other embodiments each connector in a group is monitored by monitor 106. Additionally, in some embodiments, parameters monitored for each group of connectors are not all monitored on the same connector in the group. In some embodiments, model generation module 108 processes the monitored parameters received from monitor 106 before generating reliability models for one or more of the groups of connectors 112 in interconnect 110.

In some embodiments, a reliability model includes but is not limited to: a pattern recognition model; a linear model; a parametric model; a model generated using nonlinear, non-parametric (NLNP) regression; a model generated using the known physics of the one or more mechanism causing or related to the degradation and/or failure being modeled; a known model for the degradation and/or failure being modeled; any other technique that can be used to generate a reliability model; or any combination of the above methods and techniques. In some embodiments, the NLNP regression technique includes a multivariate state estimation technique (MSET). The term “MSET” as used in this specification refers to a class of pattern recognition algorithms. For example, see [Gribok] “Use of Kernel Based Techniques for Sensor Validation in Nuclear Power Plants,” by Andrei V. Gribok, J. Wesley Hines, and Robert E. Uhrig, The Third American Nuclear Society International Topical Meeting on Nuclear Plant Instrumentation and Control and Human-Machine Interface Technologies, Washington D.C., Nov. 13-17, 2000. This paper outlines several different pattern recognition approaches. Hence, the term “MSET” as used in this specification can refer to (among other things) any technique outlined in [Gribok], including Ordinary Least Squares (OLS), Support Vector Machines (SVM), Artificial Neural Networks (ANNs), MSET, or Regularized MSET (RMSET).

In some embodiments, model-generation module 108 generates the reliability models for each group using parameters including but not limited to independent variables including: electrical resistance or measures of signal integrity for connectors 112 in the group; inferential variables that correlate to the independent variables; and for “static” parameters, additional statistical techniques including a sequential probability ratio test (SPRT) can be used. In some embodiments, SPRT tests for static parameters can include but are not limited to one or more of the following: positive and negative deviation in the mean; positive and negative deviations in the variance; positive and negative deviations in a derivative of the mean; and positive and negative deviations in a derivative of the variance. In some embodiments, monitor 106 monitors parameters related to dynamic stress conditions including but not limited to power and temperature for a connector. Additionally, in some embodiments, model-generation module 108 models monitored parameters, and the residuals between the modeled and the actual parameters are then calculated, and SPRT is applied to the residual.

In some embodiments, the relative importance and impact of stress variables on the reliability of interconnect 110 is quantified based on the reliability models generated for each group of connectors 112. For example, in one embodiment, the reliability models for each group of connectors 112 are used to determine the relative importance of design parameters, operational parameters, field environmental parameters, material and processes to the reliability of interconnect 110 based on the reliability models generated for each group.

In some embodiments, the parameters to control through proactive fault monitoring when interconnect 110 is operating in computer system 100 in the “field” are determined based on the reliability models for each group. Furthermore, in some embodiments, generating a reliability model for each group includes determining a response to impending failure of interconnect 110 based on the reliability models for each group or through alarms based on a statistical analysis, for example using SPRT, of information from the reliability models and from monitored parameters. The response can include but is not limited to one or more of the following: the action to be taken, and the urgency of the action to be taken. In some embodiments, an estimate of the remaining useful life of interconnect 110 after the alarm is determined based on the reliability models and the nature of the failure. For example, a failure may only degrade performance, or it may cause interconnect 110 to become inoperable. Note that an estimate of the time between when the alarm is raised and when a failure may be manifested can be generated based on the reliability models.

In some embodiments, the reliability models generated for each group of connectors 112 are used to generate an overall reliability model for interconnect 110, which is used to quantify the relative impact of design parameters, operational parameters, environmental parameters, and material properties and processes for purposes which can include but are not limited to optimizing cost, performance, and reliability of interconnect 110. The reliability models generated for each group of connectors 112 are used to generate the overall reliability model for interconnect 110 using established methods for generating a reliability model of a system from reliability models of the subsystems from which the system is composed.

Note that embodiments of the present invention can be used to generate reliability models for any interconnect, including interconnects other than those used for processors in computer systems such as depicted in FIG. 1B.

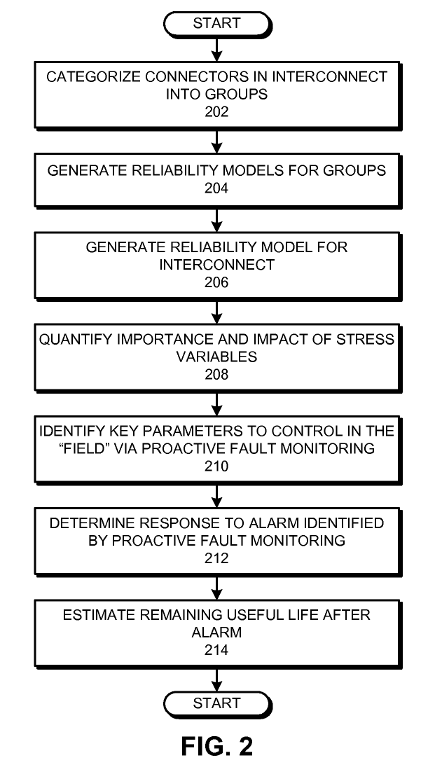

FIG. 2 presents a flowchart illustrating a process for determining a reliability of an interconnect in accordance with embodiments of the present invention. First, connectors in an interconnect are categorized into groups based on properties of the connectors (step 202). Next, reliability models are generated for each group of connectors (step 204). Then, a reliability model is generated for the interconnect based on the reliability models for each group of connectors (step 206). Then, using the reliability models for each group, the importance of and impact on the reliability of connectors in the interconnect is quantified (step 208). Also, the reliability models for each group are used to identify key parameters to monitor for an interconnect in the “field” via proactive fault monitoring (step 210). Additionally, responses to alarms generated by the reliability models during proactive fault monitoring are determined (step 212). In some embodiments, the alarms are generated using the reliability models through statistical techniques including SPRT. The reliability models can also be used to estimate the remaining life after an alarm based on information from the reliability testing (step 214).

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for determining a reliability of an interconnect, comprising:
categorizing connectors in the interconnect into a set of predetermined groups;
determining a reliability for selected groups in the set of predetermined groups; and
generating a reliability model for the interconnect based on the selected groups and the reliability of the selected groups to determine the reliability of the interconnect.

2. The method of claim 1, wherein the selected groups are selected based on at least one of:
a connector function;
a connector location;
a connector construction; and
a connector stress.

3. The method of claim 1 wherein generating the reliability model for the interconnect includes prioritizing at least two of the selected groups based on the reliability of the two selected groups.

4. The method of claim 1, wherein generating the reliability model for the interconnect includes determining a response to an alarm based on characteristics of the selected group generating the alarm.

5. The method of claim 4, wherein generating the reliability model for the interconnect includes estimating a remaining useful life of the interconnect based on the alarm.

6. The method of claim 1, wherein determining the reliability for a selected group from the set of predetermined groups includes generating a reliability model for the selected group.

7. The method of claim 1 wherein generating the reliability model for the interconnect includes generating the reliability model for the reliability of the interconnect based on a reliability model for a selected group.

8. The method of claim 1, wherein determining the reliability for the selected groups in the set of predetermined groups includes using a nonlinear, non-parametric regression technique.

9. The method of claim 8, wherein using the nonlinear, non-parametric regression technique includes using a multivariate state estimation technique (MSET).

10. The method of claim 1, wherein determining the reliability for the selected groups in the set of predetermined groups includes using a sequential probability ratio test (SPRT) technique.

11. The method of claim 10, wherein using the SPRT technique includes testing for at least one of the following:
a positive deviation in a mean;
a negative deviation in the mean;
a positive deviation in a variance;
a negative deviation in the variance;
a positive deviation in a derivative of the mean;
a negative deviation in a derivative of the mean;
a positive deviation in a derivative of the variance; and
a negative deviation in a derivative of the variance.

12. A computer-readable storage medium storing instructions that when executed by a computer cause the computer to perform a method for determining a reliability of an interconnect, the method comprising:
categorizing connectors in the interconnect into a set of predetermined groups;
determining a reliability for selected groups in the set of predetermined groups; and
generating a reliability model for the interconnect based on the selected groups and the reliability of the selected groups to determine the reliability of the interconnect.

13. The computer-readable storage medium of claim 12, wherein the selected groups are selected based on at least one of:
a connector function;
a connector location;
a connector construction; and
a connector stress.

14. The computer-readable storage medium of claim 12 wherein generating the reliability model for the interconnect includes prioritizing at least two of the selected groups based on the reliability of the two selected groups.

15. The computer-readable storage medium of claim 12, wherein generating the reliability model for the interconnect includes determining a response to an alarm based on characteristics of the selected group generating the alarm.

16. The computer-readable storage medium of claim 12 wherein generating the reliability model for the interconnect includes generating the reliability model for the reliability of the interconnect based on a reliability model for a selected group.

17. The computer-readable storage medium of claim 12, wherein determining the reliability for the selected groups in the set of predetermined groups includes using a nonlinear, non-parametric regression technique.

18. The computer-readable storage medium of claim 17, wherein using the nonlinear, non-parametric regression technique includes using a multivariate state estimation technique (MSET).

19. The computer-readable storage medium of claim 12, wherein determining the reliability for the selected groups in the set of predetermined groups includes using a sequential probability ratio test (SPRT) technique.

20. An apparatus that determines a reliability of an interconnect, the apparatus comprising:
a determining mechanism configured to determine a reliability for selected groups of connectors in the interconnect in a set of predetermined groups of connectors in the interconnect, wherein determining the reliability for the selected groups in the set of predetermined groups includes using a nonlinear, non-parametric regression technique; and
a generating mechanism configured to generate a reliability model for the interconnect based on the selected groups and the reliability of the selected groups to determine the reliability of the interconnect, wherein generating the reliability model for the interconnect includes prioritizing at least two of the selected groups based on the reliability of the two selected groups.
